(19) United States
(12) Patent Application Publication
(10) Pub. No.: US 2010/0116607 A1
(43) Pub. Date: May 13, 2010

(54) Dual seal rod guide assembly with low friction disc

(76) Inventor: Saiman Lun, Centerville, OH (US)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/291,366

(22) Filed: Nov. 7, 2008

(51) Int. Cl. F16F 9/32

(52) U.S. Cl. 188/267.2

(57) ABSTRACT

A dual seal rod guide assembly with low friction disc for use in a magneto-rheological (MR) strut is described. The dual seals separate the functions of abrasion resistance and temperature performance, with the primary seal formed of a material resistant to high temperatures and the buffer seal formed of a material resistant to the ferroelectric microparticles in the MR fluid. The porous rod guide, in conjunction with the buffer seal, allow only the MR carrier fluid to reach the bearing and primary seal. The MR carrier fluid provides internal lubrication of the bearing and primary seal. The retainer holds the assembly together and engages the rod guide flexible assembly to the housing with a low-friction disc therebetween. The disc reduces surface friction during radial movement of the rod guide.

### TECHNICAL FIELD OF INVENTION

The invention relates to a damper guide assembly for a rod of a motor vehicle strut. More particularly, this invention relates to a guide assembly which minimizes internal friction and abrasion due to radial movement of the rod. Magneto-rheological (MR) fluid is filtered through the porous rod guide, and dual seals on either side of the bearing contain this carrier fluid, thus lubricating the bearing. A low friction disc is disposed between the tubular housing and the flexible assembly to reduce friction induced wear.

### BACKGROUND OF INVENTION

A magneto-rheological (MR) strut is a type of damper used in vehicle suspensions to absorb shock and as part of the load bearing structure. The MR strut is a hydraulic vibration damper which uses MR fluid together with a device that generates a magnetic field. A typical MR fluid contains ferromagnetic particles suspended in a low viscosity fluid. When the MR fluid is subjected to a magnetic field, the ferromagnetic particles align parallel to the magnetic field, changing the apparent viscosity of the fluid. Therefore, the damping effect of the MR strut can be adjusted by varying the strength of the applied magnetic field.

In U.S. Pat. No. 6,840,358, incorporated by reference, Kos, et al. details the structure of a motor vehicle strut and a rod guide assembly for the strut. The rod is slidable in the housing and is held in alignment by a guide assembly. Features of the guide assembly include a compliant member adjacent a sleeve, a seal, a seal cover and a retainer attached to the housing. This rod guide configuration is limited by the ability of the single seal to resist abrasion from the MR fluid at the operating temperatures of the strut. A second limitation of this design is that the upper and lower face seals allow radial travel of the rod guide relative to the rod guide housing, resulting in face seal wear.

In U.S. Pat. No, 6,883,649, also incorporated by reference herein, Lun discloses a closing system for use with a MR damper. The closing system provides rod lubrication by using an internal filter to remove the microparticles from the MR fluid, and lubricating the system with MR carrier fluid.

It is desired to have a rod guide assembly for a MR strut which separates the temperature performance and abrasion resistance of the seals, while providing rod lubrication without the need for lubricant replenishment. It is also desired to reduce wear due to friction caused from radial movement of the rod.

### SUMMARY OF THE INVENTION

In accordance with this invention, a guide assembly for a rod of a motor vehicle strut provides dual seals to separate the functions of temperature performance and abrasion resistance, the primary seal and the buffer seal. The primary seal withstands the entire temperature range of operation of the MR strut. The buffer seal prevents the microparticles in the MR fluid from abrading the bearing, allowing only clean carrier fluid to lubricate the bearing and the primary seal. The porous rod guide acts as a filter, allowing only clean carrier fluid of the MR fluid to pass through to the bearing. The rod guide flexible assembly is a one piece molded assembly made from two inserts with a flexible member in between. The flexible assembly outer insert has an outer diameter seal which may be molded to the flexible assembly or a separate o-ring. The outer diameter seal provides sealing contact between the flexible assembly and the rod guide housing.

The low-friction disc, disposed between the rod guide flexible assembly and the rod guide housing, reduces surface friction caused by radial movement of the rod. Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is an exploded view of dual seal rod guide assembly with low friction disc.

FIG. 2 is a cross-sectional view of dual seal rod guide assembly with low friction disc.

FIG. 3 is a cross-sectional view of the flexible assembly.

### DETAILED DESCRIPTION OF INVENTION

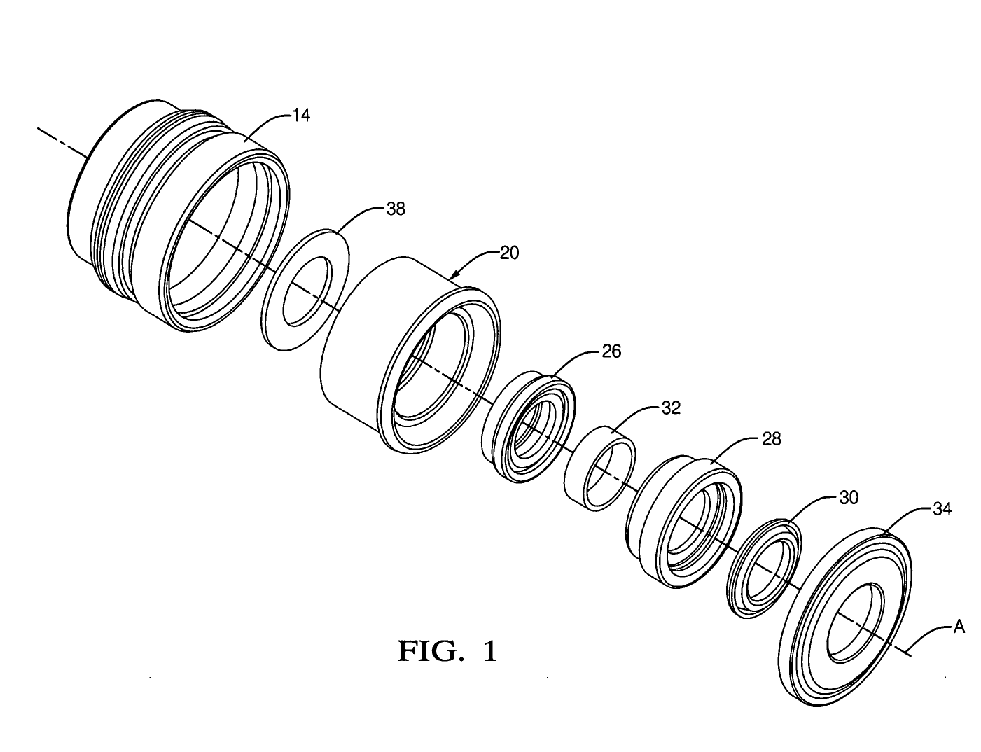

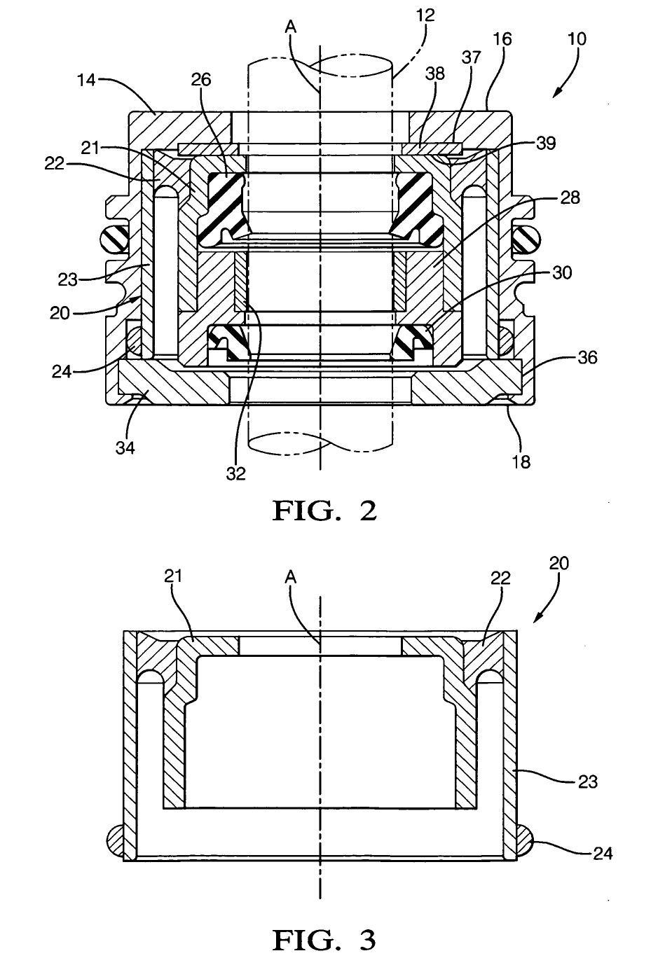

In accordance with a preferred embodiment of this invention, referring to FIGS. 1-3, a rod guide assembly 10 about an axis A for a rod 12 of a motor vehicle strut is shown. The rod guide assembly 10 includes a tubular rod guide housing 14. The tubular housing 14 has a first end 16 and a second end 18. The first end 16 is configured with a clearance hole to accept the rod 12. A low friction disc 38 has a first surface 37 in contact with the inner face of the first end 16 of the housing 14. The disc 38 is preferably made of Teflon, however any material that would reduce friction on the inner face of the first end 16 of the housing 14 would be acceptable. Rod 12 passes through the center of the disc 38. The second surface 39 of the disc 38 is in contact with the rod guide flexible assembly 20. The disc 38 isolates the inner face of the first end 16 of housing 14 and the rod guide flexible assembly 20, reducing friction caused by radial movement of the rod 12. The rod guide flexible assembly 20 comprises a flexible member 22 molded between an inner insert 21 and an outer insert 23. The outer insert 23 is molded to an outer diameter seal 24, which seals the flexible assembly 20 to the rod guide housing 14. The flexible assembly 20 provides at least one opening for carrying a fluid. A primary seal 26 is positioned coaxially, along the same axis A, within the flexible assembly 20. The inner diameter of the primary seal 26 is in seal able contact with the rod 12. The outer diameter of the primary seal 26 is in seal able contact with the inner insert 21 of the flexible guide assembly 20. A rod guide 28 is adjacent the primary seal. The rod guide 28 is made of a porous material that is compatible with MR fluids, preferably powdered metal. The rod guide 28 is disposed adjacent the primary seal 26 and coaxially within the flexible assembly 20. The rod guide 28 is a barrier to the ferroelectric microparticles in the MR fluid, allowing only the MR carrier fluid to pass through. The MR carrier fluid provides excellent lubrication between the rod 12 and the primary seal 26 as well as for the bearing 32. Bearing 32 is located coaxial and internal the rod guide 28. Bearing 28 and MR carrier fluid for lubrication of bearing 28 are contained axially between primary seal 26 on one end and buffer seal 30 on the other. Buffer seal 30 has an inside diameter adjacent the rod 12 and an outside diameter adjacent the rod guide 28, and provides a barrier to the ferroelectric microparticles in the MR fluid. The buffer seal 30 prevents abrasion of the bearing 32 and the primary seal 26 by ferroelectric microparticles in the MR fluid. The annular retainer 34 is disposed adjacent the buffer seal 30 and coaxial the tubular housing 14. The inside diameter of annular retainer 34 is adjacent rod 12. The retainer 34 is configured such that the outside diameter can be press fit into internal groove 36 of housing 14 proximate housing second end 18. When retainer 34 is in position it acts to engage rod guide flexible assembly 20 to housing first end 16 with disc 38 therebetween. Installation of retainer 34 completes the rod guide assembly 10 by holding all of the aforementioned elements of the assembly 10 in place relative to each other.

While this invention has been described in terms of the preferred embodiments thereof, it is not intended to be so limited, but rather only to the extent set forth in the claims that follow.

We claim:

1. A guide assembly for a rod of a motor vehicle strut, comprising:
a tubular housing about an axis, said housing having a first end and a second end;
a disc having a first surface and a second surface disposed within the housing, said disc first surface adjacent housing first end;
a flexible assembly coaxially disposed within the housing adjacent the disc second surface, wherein the flexible assembly defines at least one opening for carrying a fluid;
a primary seal positioned coaxially within the flexible assembly, said seal having an inside diameter engaging the rod and an outside diameter engaging the flexible assembly;
a rod guide disposed adjacent the primary seal and coaxially within the flexible assembly;
a bearing disposed adjacent the primary seal, said bearing positioned between the rod and the rod guide;
a buffer seal disposed adjacent the bearing and opposite the primary seal, said buffer seal coaxially positioned between the rod and the rod guide; and
a retainer disposed adjacent the buffer seal and coaxially within the housing, said retainer configured to press fit into a groove at the second end of the tubular housing, said retainer engaging said flexible assembly and said first end of tubular housing with said disc disposed therebetween; whereby radial movement of the rod induces deformation of the flexible member and negligible friction between the flexible member and the housing.

2. The guide assembly in claim 1, wherein the tubular housing first end is configured to receive the rod and tubular housing second end is configured to receive the retainer.

3. The guide assembly in claim 1, wherein the disc is made of a low friction material.

4. The guide assembly in claim 3, wherein the disc is made of Teflon.

5. The guide assembly in claim 1, wherein the flexible assembly comprises a flexible member molded to an inner insert and an outer insert, said inner insert having an inner diameter adjacent the rod and said outer insert having an outside diameter adjacent the housing.

6. The guide assembly in claim 1, wherein the fluid is magneto-rheological (MR) fluid comprising ferroelectric microparticles suspended in a carrier fluid.

7. The guide assembly in claim 1, wherein the primary seal is made of a material resistant to high temperatures.

8. The guide assembly in claim 1, wherein the rod guide is made of a porous material compatible with MR fluid, said rod guide configured to filter the MR fluid and enable lubrication of bearing and primary seal with carrier fluid.

9. The guide assembly in claim 1, wherein the buffer seal isolates MR fluid from filtered MR fluid.

10. The guide assembly in claim 1, wherein the retainer comprising an outer diameter adapted to couple to an inner diameter groove at second end of housing and captively hold guide assembly to housing.
